(19) United States
(12) Patent Application Publication
(10) Pub. No.: US 2017/0045662 A1
(43) Pub. Date: Feb. 16, 2017

(54) LIGHT GUIDE PLATE AND BACKLIGHT MODULE

(71) Applicants: Shenzhen China Star Optoelectronics Technology Co., Ltd., Shenzhen (CN); Wuhan China Star Optoelectronics Technology Co., Ltd., Wuhan (CN)

(72) Inventor: Yingbo ZHENG, Shenzhen (CN)

(73) Assignees: Shenzhen China Star Optoelectronics Technology, Shenzhen (CN); Wuhan China Star Optoelectronics Technology Co., Ltd., Wuhan (CN)

(21) Appl. No.: 14/649,556

(22) PCT Filed: Apr. 3, 2015
(86) PCT No.: PCT/CN2015/075932

§ 371 Date: Jun. 4, 2015

(30) Foreign Application Priority Data
Mar. 30, 2015 (CN) 201510143672.2

(51) Int. Cl. F21V 8/00

(52) U.S. Cl. CPC G02B 6/0016; G02B 6/002; G02B 6/0068; G02B 6/0046

(57) ABSTRACT

A light guide plate and a backlight module are provided, the light guide plate has a wedge-shaped light incident portion and a conducting portion; the wedge-shaped light incident portion includes a light incident surface and a first light guide surface; the first light guide surface is disposed on an upper side of the light incident surface, having a scattering surface for scattering the incident light and a conducting surface for directional transmission of the incident light, the scattering surface is disposed on a bright light source area, and the conducting surface is disposed on a dark light source area.

### FIELD OF THE INVENTION

The present invention relates to a field of backlight, and in particular to a light guide plate and a backlight module.

### BACKGROUND OF THE INVENTION

With the development of display technology, LED backlight sources have become a mainstream backlight source for display devices. The LED backlight source is generally packaged in the form of a light bar by multiple LEDs arranged in rows, thereby forming a backlight source. Such a package is favorable for the arrangement of circuits and heat dissipation of the back light.

But the LED light source 11 is a dot light source, such that a radial hotspot will generally appear on a light incident side of light guide plate close to a single LED, resulting in a display shortage.

In order to reduce the hotspot phenomenon, the designer provides a number of V-shaped structures 121 on the light incident surface of the light guide plate 12, as shown in FIG. 1, which is a schematic structural diagram of the conventional backlight module. Such a light guide plate 12 can better reduce the hotspot phenomenon on the light incident side of the light guide plate, however it has the following disadvantages:

1. The V-shaped structure 121 decreases the optical coupling efficiency of the light guide plate 12, thereby reducing the brightness of the backlight source.

2. The machining process for the V-shaped structure 121 is more difficult, and cracking phenomenon often occurs, resulting in poor quality of the light guide plate 12.

Therefore, it is necessary to provide a light guide plate and a backlight module to solve the existing problems of the conventional art.

### SUMMARY OF THE INVENTION

The objective of the present invention is to provide a light guide plate and a backlight module which can eliminate the hotspot phenomenon, and further to provide high brightness of the backlight source and a simple machining process to solve the technical problems of hotspot phenomenon or lower backlight brightness in a conventional light guide plate and backlight module.

In order to solve the above problems, the present invention provides the technical solution as follows:

One embodiment of the present invention provides a light guide plate, comprising: a wedge-shaped light incident portion for homogenizing an incident light; and a conducting portion for transmitting the homogenized incident light to a corresponding liquid crystal display panel; wherein the wedge-shaped light incident portion comprises a light incident surface for receiving the incident light, and a first light guide surface disposed on an upper side of the light incident surface including a scattering surface for scattering the incident light and a conducting surface for directional transmitting the incident light, the scattering surface is disposed on a bright light source area of the light guide plate, and the conducting surface is disposed on a dark light source area of the light guide plate, wherein the bright light source area is an area of the light guide plate corresponding to an LED light source, the dark light source area is an area of the light guide plate corresponding to a space between two adjacent LED light sources; wherein the light incident surface is a polished surface, a surface of the scattering surface is a polished surface, a surface of the conducting surface is provided with a first light-conducting microstructure.

One embodiment of the present invention further provides a light guide plate, comprising: a wedge-shaped light incident portion for homogenizing an incident light; and a conducting portion for transmitting the homogenized incident light to a corresponding liquid crystal display panel; wherein the wedge-shaped light incident portion comprises a light incident surface for receiving the incident light, and a first light guide surface disposed on an upper side of the light incident surface including a scattering surface for scattering the incident light and a conducting surface for directional transmitting the incident light, the scattering surface is disposed on a bright light source area of the light guide plate, the conducting surface is disposed on a dark light source area of the light guide plate, wherein the bright light source area is an area of the light guide plate corresponding to an LED light source, the dark light source area is an area of the light guide plate corresponding to a space between two adjacent

LED light sources.

In the light guide plate according to the present invention, a surface of the scattering surface is a polished surface, a surface of the conducting surface is provided with a first light-conducting microstructure.

In the light guide plate according to the present invention, the first light guide surface is perpendicular to the light incident surface.

In the light guide plate according to the present invention, the first light-conducting microstructure is perpendicular to the light incident surface.

In the light guide plate according to the present invention, the first light-conducting microstructure has a pore diameter less than 50 microns.

In the light guide plate according to the present invention, the wedge-shaped light incident portion further comprises: a second light guide surface disposed on the upper side of the light incident surface, and disposed between the first light guide surface and the conducting portion, a surface of the second light guide surface is provided with a second light-conducting microstructure for directional transmission of the incident light of the bright light source area to the dark light source area.

In the light guide plate according to the present invention, the second light guide surface and the light incident surface form an acute angle.

In the light guide plate according to the present invention, the second light-conducting microstructure has a pore diameter less than 50 microns.

In the light guide plate according to the present invention, the light incident surface is a polished surface.

One embodiment of the present invention further provides a backlight module, comprising an LED light source and a light guide plate, wherein the light guide plate comprises: a wedge-shaped light incident portion for homogenizing an incident light; and a conducting portion for transmitting the homogenized incident light to a corresponding liquid crystal display panel; wherein the wedge-shaped light incident portion comprises a light incident surface for receiving the incident light; and a first light guide surface disposed on an upper side of the incident surface including a scattering surface for scattering the incident light and a conducting surface for directional transmission of the incident light, the scattering surface is disposed on a bright light source area of the light guide plate, the conducting surface is disposed on a dark light source area of the light guide plate, wherein the bright light source area is an area of the light guide plate corresponding to an LED light source, the dark light source area is an area of the light guide plate corresponding to a space between two adjacent LED light sources.

In the backlight module according to the present invention, a surface of the scattering surface is a polished surface, a surface of the conducting surface is provided with a first light-conducting microstructure.

In the backlight module according to the present invention, the first light guide surface is perpendicular to the light incident surface.

In the backlight module according to the present invention, the first light-conducting microstructure is perpendicular to the light incident surface.

In the backlight module according to the present invention, the first light-conducting microstructure has a pore diameter less than 50 microns.

In the backlight module according to the present invention, the wedge-shaped light incident portion further comprises: a second light guide surface disposed on the upper side of the light incident surface, and disposed between the first light guide surface and the conducting portion, a surface of the second light guide surface is provided with a second light-conducting microstructure for directional transmission of the incident light of the bright light source area to the dark light source area.

In the backlight module according to the present invention, the second light guide surface and the light incident surface form an acute angle.

In the backlight module according to the present invention, the second light-conducting microstructure has a pore diameter less than 50 microns.

In the backlight module according to the present invention, the second light-conducting microstructure has a pore diameter less than 50 microns.

Compared with the conventional light guide plate and backlight module, the light guide plate and the backlight module of the present invention homogenize the incident light via the first light guide face, so that they are able to eliminate the hotspot phenomenon on the basis of maintaining the brightness of the backlight source, and the machining process is simple. The technical problems of hotspot phenomenon or lower backlight brightness in the conventional light guide plate and backlight module are solved.

For a better understanding of the aforementioned content of the present invention, preferable embodiments are illustrated in accordance with the attached figures for further explanation.

### BRIEF DESCRIPTION OF THE DRAWINGS

FIG. 1 is a schematic structural diagram of a conventional backlight module;

FIG. 2A is a plan-view structural diagram of a backlight module according to one preferred embodiment of the present invention;

FIG. 2B is a cross-section diagram taken along section line A-A′ from FIG. 2A;

FIG. 3 is a side-view structural diagram of a backlight module according to one preferred embodiment of the present invention.

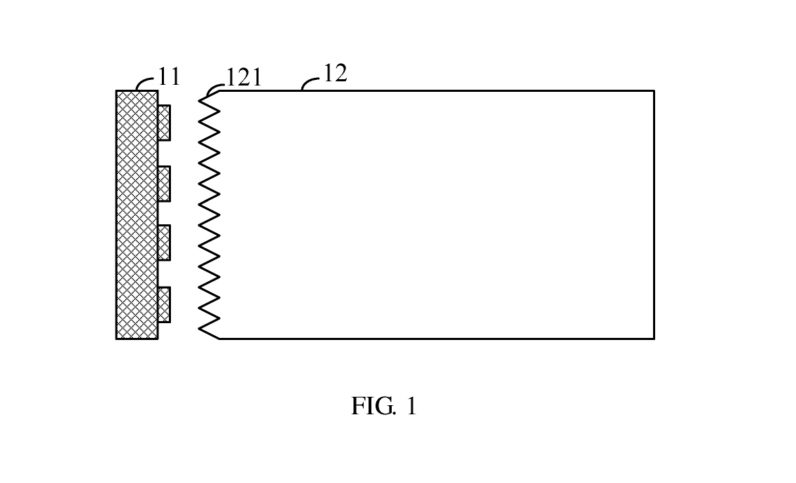

### DETAILED DESCRIPTION OF THE PREFERRED EMBODIMENTS

The following descriptions of the respective embodiments are specific embodiments capable of being implemented for illustrations of the present invention, with reference to the appended figures. The terms up, down, front, rear, left, right, interior, exterior, side, etcetera are merely directions referring to the appended figures. Therefore, such directions are employed for explaining and understanding the present invention, but are not limitations thereto.

In the drawings, the similar components are represented by the same symbols.

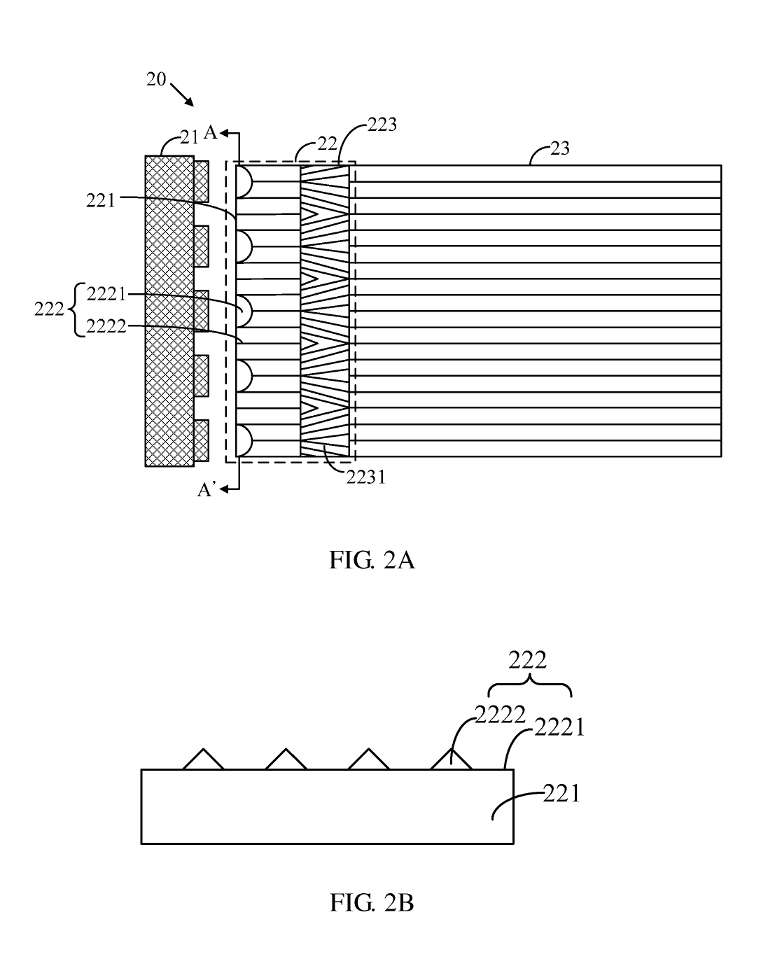

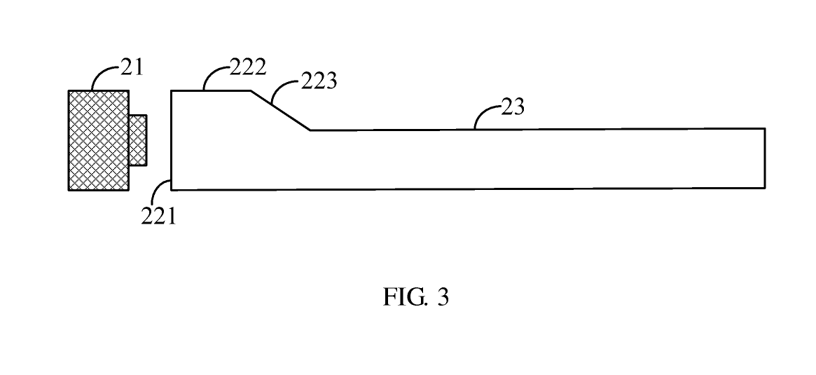

Refer to FIG. 2A, FIG. 2B, and FIG. 3, where FIG. 2A is a plan-view structural diagram of a backlight module according to one preferred embodiment of the present invention; FIG. 2B is a cross-section diagram taken along section line A-A′ from FIG. 2A; and FIG. 3 is a side-view structural diagram of a backlight module according to one preferred embodiment of the present invention. The backlight module 20 according to the preferred embodiment of the present invention comprises an LED light source 21 and a light guide plate.

The light guide plate comprises a wedge-shaped light incident portion 22 and a conducting portion 23; the wedge-shaped light incident portion 22 is for homogenizing an incident light, the conducting portion 23 is for transmitting the homogenized incident light to a corresponding liquid crystal display panel.

The wedge-shaped light incident portion 22 includes a light incident surface 221, a first light guide surface 222, and a second light guide surface 223. The light incident surface is for receiving the incident light, in order to ensure the light incident effect, the light incident surface 221 is preferably a polished surface; the first light guide surface 222 could be disposed on an upper side of the light incident surface 221, the first light guide surface 222 includes a scattering surface 2221 for scattering the incident light, and a conducting surface 2222 for directional transmission of the incident light.

The scattering surface 2221 is disposed on a bright light source area of the light guide plate, and the conducting surface 2222 is disposed on a dark light source area of the light guide plate, wherein the bright light source area is an area of the light guide plate corresponding to an LED light source 21, the dark light source area is an area of the light guide plate corresponding to a space between two adjacent LED light sources 21.

The second light guide surface 223 is also disposed on the upper side of the light incident surface 221, and is disposed between the first light guide surface 222 and the conducting portion 23, a surface of the second light guide surface 223 is provided with a second light-conducting microstructure 2231 for directional transmission of the incident light of the bright light source area to the dark light source area.

Of course, the first light guide surface 222 and the second light guide surface 223 could also be disposed on a lower side of the light incident surface 221, or disposed on both the upper side and the lower side of the light incident surface.

A surface of the scattering surface 2221 of the first light guide surface 222 of the light guide plate according to the backlight module 20 of the preferred embodiment is a polished surface, such that it can facilitate the light scattering of the incident light corresponding to the bright light source area; a surface of the conducting surface 2222 of the first light guide surface 222 is provided with a first light-conducting microstructure 2223, the configuration of the first light-conducting microstructure 2223 is more conducive to the incident light of the dark light source area being transmitted along an extending direction of the first light-conducting microstructure 2223.

In the preferred embodiment, the first light guide surface 222 is perpendicular to the light incident surface, and the first light-conducting microstructure 2223 on the surface of the first light conducting surface 222 is perpendicular to the light incident surface. In order to ensure the orientation of the first light-conducting microstructure 2223, the first light-conducting microstructure 2223 has a pore diameter less than 50 microns.

The second light-conducting microstructure 2231 of the second light guide surface 223 of the light guide plate according to the backlight module 20 of the preferred embodiment can allow the incident light to be transmitted along an extending direction of the second light-conducting microstructure 2231, therefore the incident light of the bright light source area is directionally transmitted to the dark light source area.

In the preferred embodiment, the second light guide surface 223 and the light incident surface 221 form an acute angle in order to facilitate the condensing operation. At the same time, the second light-conducting microstructure 2231 has a pore diameter less than 50 microns, to ensure the orientation of the second light-conducting microstructure 2231.

A specific structure is shown in FIG. 3, where the first light-conducting microstructure 2223 and the second light-conducting microstructure 2231 are not displayed.

When the backlight module 20 of the preferred embodiment is used, an emitting light of the LED light source 21 appears in a staggered light-and-shade pattern because of the distribution of the LED light source 21, wherein the area of the light guide plate corresponding to the LED light source 21 is defined as the bright light source area, the area of the light guide plate corresponding to a space between two adjacent LED light sources 21 is defined as the dark light source area.

After the light-and-shade staggered incident light 221 is transmitted to the light guide plate via the light incident surface 221, the first light guide surface 222 of the wedge-shaped light incident light portion 22 of the light guide plate homogenizes the incident light, wherein the scattering surface 2221 of the first light-conducting surface 222 disposed in the bright light source area of the light guide plate can operate a light scattering to the incident light in the bright light source area, thereby reducing the incident light in the bright light source area, and increasing the incident light in the dark light source area; the conducting surface 2222 of the first light guide surface 222 is disposed on the dark light source area of a light guide plate, the first light-conducting microstructure 2223 on the conducting surface 2222 can prevent the incident light of the dark light source area from scattering, thereby further avoiding reduction of the incident light in the dark light source area. Thus, after passing through the first light guide surface, the brightness uniformity of the incident light of the light guide plate is improved.

After that, the second light guide surface 223 of the wedge-shaped light incident portion 22 further homogenizes the incident light, the second light-conducting microstructure 2231 on the second light guide surface 223 can effectively directionally transmit the incident light in the bright light source area to the dark light source area of the light guide plate, thus reducing the incident light in the bright light source area, and increasing the incident light in the dark light source area, and further improving the brightness uniformity of the incident light of the light guide plate.

At the same time, the second light guide surface 223 and the light incident surface 221 form an acute angle, so that the homogenized incident light can be condensed, further improving the brightness of the backlight source.

Through the configuration of the first light guide surface 222 and the second light guide surface 223 of the wedge-shaped light incident portion 22 of the light guide plate, the homogenization treatment to the incident light goes very well, and the hotspot phenomenon is avoided.

The section of the first light-conducting microstructure 2223 of the first light guide surface 222 and the second light-conducting microstructure 2231 of the second light guide surface 223 could be triangular, arc-shaped or other shapes which are able to restrict light from scattering. Such an incident surface of the light guide plate can adopt a polished surface which is used to improve the light coupling efficiency, without providing the V-shaped structure to avoid the hotspot phenomenon.

The light guide plate and the backlight module of the present invention homogenize the incident light via the first light guide face and the second light guide surface, which eliminates the hotspot phenomenon on the basis of maintaining the brightness of the backlight source, and the machining process is simple. The technical problems of hotspot phenomenon or lower backlight brightness in the conventional light guide plate and backlight module are solved.

The embodiments were chosen and described in order to explain the principles of the disclosure and their practical application so as to activate others skilled in the art to utilize the disclosure and various embodiments and with various modifications as are suited to the particular use contemplated. Alternative embodiments will become apparent to those skilled in the art to which the present disclosure pertains without departing from its spirit and scope. Accordingly, the scope of the present invention is defined by the appended claims rather than the foregoing description and the exemplary embodiments described therein.

What is claimed is:

1. A light guide plate, comprising:
a wedge-shaped light incident portion, for homogenizing an incident light; and
a conducting portion, for transmitting the homogenized incident light to a corresponding liquid crystal display panel;
wherein the wedge-shaped light incident portion comprises:
a light incident surface, for receiving the incident light; and
a first light guide surface disposed on an upper side of the light incident surface, including a scattering surface for scattering the incident light and a conducting surface for directional transmission of the incident light, the scattering surface being disposed on a bright light source area of the light guide plate, and the conducting surface being disposed on a dark light source area of the light guide plate, wherein the bright light source area is an area of the light guide plate corresponding to a (light emitted diode) LED light source, the dark light source area is an area of the light guide plate corresponding to a space between two adjacent LED light sources;
wherein the light incident surface is a polished surface, a surface of the scattering surface is a polished surface, a surface of the conducting surface is provided with a first light-conducting microstructure.

2. A light guide plate, comprising:
a wedge-shaped light incident portion, for homogenizing an incident light; and
a conducting portion, for transmitting the homogenized incident light to a corresponding liquid crystal display panel;
wherein the wedge-shaped light incident portion comprises:
a light incident surface, for receiving the incident light; and
a first light guide surface disposed on an upper side of the light incident surface, including a scattering surface for scattering the incident light and a conducting surface for directional transmitting the incident light, the scattering surface being disposed on a bright light source area of the light guide plate, and the conducting surface being disposed on a dark light source area of the light guide plate, wherein the bright light source area is an area of the light guide plate corresponding to an LED light source, the dark light source area is an area of the light guide plate corresponding to a space between two adjacent LED light sources.

3. The light guide plate claimed in claim 2, wherein a surface of the scattering surface is a polished surface, and a surface of the conducting surface is provided with a first light-conducting microstructure.

4. The light guide plate claimed in claim 3, wherein the first light guide surface is perpendicular to the light incident surface.

5. The light guide plate claimed in claim 4, wherein the first light-conducting microstructure is perpendicular to the light incident surface.

6. The light guide plate claimed in claim 3, wherein the first light-conducting microstructure has a pore diameter less than 50 microns.

7. The light guide plate claimed in claim 2, wherein the wedge-shaped light incident portion further comprises:
a second light guide surface disposed on the upper side of the light incident surface, and disposed between the first light guide surface and the conducting portion, a surface of the second light guide surface being provided with a second light-conducting microstructure for directional transmission of the incident light of the bright light source area to the dark light source area.

8. The light guide plate claimed in claim 7, wherein the second light guide surface and the light incident surface form an acute angle.

9. The light guide plate claimed in claim 7, wherein the second light-conducting microstructure has a pore diameter less than 50 microns.

10. The light guide plate claimed in claim 2, wherein the light incident surface is a polished surface.

11. A backlight module, comprising an LED light source and a light guide plate, wherein the light guide plate comprises:
a wedge-shaped light incident portion, for homogenizing an incident light; and
a conducting portion, for transmitting the homogenized incident light to a corresponding liquid crystal display panel;
wherein the wedge-shaped light incident portion comprises:
a light incident surface, for receiving the incident light; and
a first light guide surface disposed on an upper side of the incident surface, including a scattering surface for scattering the incident light and a conducting surface for directional transmitting the incident light, the scattering surface is disposed on a bright light source area of the light guide plate, and the conducting surface is disposed on a dark light source area of the light guide plate, wherein the bright light source area is an area of the light guide plate corresponding to a light emitted diode (LED) light source, the dark light source area is an area of the light guide plate corresponding to a space between two adjacent LED light sources.

12. The backlight module claimed in claim 11, wherein a surface of the scattering surface is a polished surface, a surface of the conducting surface is provided with a first light-conducting microstructure.

13. The backlight module claimed in claim 12, wherein the first light guide surface is perpendicular to the light incident surface.

14. The backlight module claimed in claim 13, wherein the first light-conducting microstructure is perpendicular to the light incident surface.

15. The backlight module claimed in claim 12, wherein the first light-conducting microstructure has a pore diameter less than 50 microns.

16. The backlight module claimed in claim 11, wherein the wedge-shaped light incident portion further comprises:
a second light guide surface disposed on the upper side of the light incident surface, and disposed between the first light guide surface and the conducting portion, a surface of the second light guide surface being provided with a second light-conducting microstructure for directional transmission of the incident light of the bright light source area to the dark light source area.

17. The backlight module claimed in claim 16, wherein the second light guide surface and the light incident surface form an acute angle.

18. The backlight module claimed in claim 16, wherein the second light-conducting microstructure has a pore diameter less than 50 microns.

19. The backlight module claimed in claim 11, wherein the second light-conducting microstructure has a pore diameter less than 50 microns.
